(19) United States
(12) Patent Application Publication
(10) Pub. No.: US 2020/0317888 A1
(43) Pub. Date: Oct. 8, 2020

(54) Novel Nano Particulate Polymer Compositions

(71) Applicant: Paul Albee, Lambertville, NJ (US)

(72) Inventor: Paul Albee, SR., Lambertville, NJ (US)

(21) Appl. No.: 15/983,175

(22) Filed: May 18, 2018

(51) Int. Cl. C08K 7/02; C08K 5/06; C08K 5/20

(52) U.S. Cl. CPC C08K 7/02; C08K 2201/011; C08K 5/20; C08K 5/06

(57) ABSTRACT

The present invention comprises a process for the preparation of a dry, free flowing nanoparticulate concentrate that is free of particle agglomeration and allows for the maximum dispersion of nano-cellulose crystals, nano-cellulose fibers, chitin nano whiskers and nano chitosan in hydrophobic polymers. These are then useful in the manufacture of nano composite materials and nano fillers which are then useful in the preparation many plastic application areas, such as the manufacture of film, fiber, sheet, blow molded articles and foamed polymers.

### FIELD OF THE INVENTION

The present invention relates generally to chemical compositions that are useful as fillers and stabilizers that can provide significant improvements in the physical properties, barrier properties, chemical resistance and surface modifications of polymer compounds and blends. More specifically, the present invention relates to sub-micron sized nano-fillers

### BACKGROUND OF THE INVENTION

In order to maximize the full potential of nano-fillers that can provide significant improvements in the physical properties, barrier properties, chemical resistance and surface modifications of polymer nano-compositions, the nano-particle must be compatible with the polymer matrices and well dispersed. The major obstacles in the composite manufacture of commercialized products containing nano-cellulose and or nano-chitin fillers, has been the aggregation of nano-particles (both nano-cellulose and chitin) prior to and during compounding and the poor dispersion of the hydrophilic nano-particles in most hydrophobic polymers such as polyethylene (PE), polypropylene (PP), polylactic acid? (PLA), poly vinyl chloride (PVC) and (?) TPE). This results from the poor interfacial adhesion between the nano-particles and the polymer. By eliminating the water and moisture associated with these nano-particles nano-particle size fillers, such as calcium carbonate (CaC0₃), ZnO, clays, silicas and other products have been developed which offer unique benefits over their micron and submicron counter parts if dispersed uniformly in the polymer or polymer system. However, they all require a different technical approach in order to maximize their dispersion in polymer systems and maximize

The polymer/filler interface adhesion; nano-cellulose, nano-chitin and nano-chitosan fillers provide the same challenges. There are no exceptions. In fact, the dispersion of nano-cellulose and nano-chitin fillers can be more difficult, due to the adhesion of the nano-particles in the dry state. Both nano-cellulose fillers and nano-chitin fillers are produced in water. The water must be eliminated prior to the addition into non-water-soluble polymers and polymer systems. This creates a dilemma and is one of the first challenges that must be overcome in order to commercialize the use of these fillers in non-water-soluble polymers such as polypropylene, polyethylene, poly-lactic acid (PLA) and polyvinyl chloride (PVC).

Nano-particle size fillers, such as calcium carbonate (CaCO₃), zinc oxide (ZnO), clays, silicas and mixtures thereof offer unique benefits over their micron and submicron counter parts if dispersed uniformly in the polymer or polymer system. However, they all require a different technical approach to maximize their dispersion in polymers and maximizing the polymer/filler interface adhesion; nano-cellulose, nano-chitin and nano-chitosan are no exceptions. The dispersion of nano-cellulose and nano-chitin fillers can be more difficult, due to the adhesion of the nano-particles in the dry state. Both nano-cellulose fillers and nano-chitin fillers are produced in water. The water must be eliminated prior to the addition of these particles into non-water-soluble polymers and polymer systems. This creates a dilemma and is one of the first challenges that must be overcome in order to commercialize the use of these fillers in non-water-soluble polymers such as polypropylene, polyethylene (PE), poly-lactic acid (PLA) and polyvinyl chloride (PVC).

The present invention comprises a commercially scalable process that enables the manufacture of a dry, free flowing powder or granule (free of water), that and eliminates particle agglomeration and develops maximum dispersion of the nano-filler in the non-water-soluble polymers such as polypropylene (PP), polyethylene (PE), poly-lactic acid (PLA) and polyvinyl chloride (PVC). The dispersion of the nano-fillers and the contact adhesion between the filler and the polymers is extremely good.

This invention is based partly on the discovery that the nano-cellulose and or nano-chitin particles having an extremely small effective average particle size can be prepared by wet milling in the presence of grinding media in conjunction with a surface modifier, and that such particles are stable and do not appreciably flocculate or agglomerate due to interparticle attractive forces and can be formulated into pharmaceutical compositions exhibiting unexpectedly high bioavailability. While the invention is described herein primarily in connection with its preferred utility, i.e., with respect to nano-particulate drug substances for use in pharmaceutical compositions, it is also believed to be useful in other applications such as the formulation of particulate cosmetic compositions and the preparation of particulate dispersions for use in image and magnetic recording elements.

The grinding media for the particle size reduction step can be selected from rigid media preferably spherical or particulate in form having an average size less than about 3.0 mm and, more preferably, less than about 1.0 mm. Such media desirably can provide the particles of the invention with shorter processing times and impart less wear to the milling equipment. The selection of material for the grinding media is not believed to be critical. Zirconium oxide, such as 95% ZrO stabilized with magnesia, zirconium silicate, and glass grinding media provide particles having levels of contamination which are believed to be acceptable for the preparation of pharmaceutical compositions. However, other media, such as stainless steel, titania, alumina, and 95% ZrO stabilized with yttrium, are expected to be useful. Preferred media have a density greater than about 3.0 g/cm³ Methods for the preparation of nano particles and nanoparticulate compositions are well known in the art and more specific details and teachings on the processes for their preparation may be found in U.S. Pat. Nos. 5,145,684 to Liversidge et. al; U.S. Pat. No. 6,165,506 to Jain et. al. and Methods of Making Nanoparticulate compositions are described, for example, in U.S. Pat. Nos. 5,518,187 and 5,862,999, both for “Method of Grinding Pharmaceutical Substances;” U.S. Pat. No. 5,718,388, for “Continuous Method of Grinding Pharmaceutical Substances;” and U.S. Pat. No. 5,510,118 for “Process of Preparing Therapeutic Compositions Containing Nanoparticles all of which are incorporated herein by reference.

Nanoparticulate compositions and their preparation are also described, for example, in U.S. Pat. No. 5,298,262 for “Use of Ionic Cloud Point Modifiers to Prevent Particle Aggregation During Sterilization;” U.S. Pat. No. 5,302,401 for “Method to Reduce Particle Size Growth During Lyophilization;” U.S. Pat. No. 5,336,507 for “Use of Charged Phospholipids to Reduce Nanoparticle Aggregation;” U.S. Pat. No. 5,340,564 for “Formulations Comprising Olin 10-G to Prevent Particle Aggregation and Increase Stability;” U.S. Pat. No. 5,346,702 for “Use of Non-Ionic Cloud Point Modifiers to Minimize Nanoparticulate Aggregation During Sterilization;” U.S. Pat. No. 5,352,459 for “Use of Purified Surface Modifiers to Prevent Particle Aggregation During Sterilization;” U.S. Pat. Nos. 5,399,363 and 5,494,683, both for “Surface Modified Anticancer Nanoparticles;” U.S. Pat. No. 5,429,824 for “Use of Tyloxapol as a Nanoparticulate Stabilizer;” U.S. Pat. No. 5,470,583 for “Method of Preparing Nanoparticle Compositions Containing Charged Phospholipids to Reduce Aggregation;” U.S. Pat. No. 5,518,738 for “Nanoparticulate NSAID Formulations;” U.S. Pat. No. 5,552,160 for “Surface Modified NSAID Nanoparticles;” U.S. Pat. No. 5,560,931 for “Formulations of Compounds as Nanoparticulate Dispersions in Digestible Oils or Fatty Acids;” U.S. Pat. No. 5,565,188 for “Polyalkylene Block Copolymers as Surface Modifiers for Nanoparticles;” U.S. Pat. No. 5,569,448 for “Sulfated Non-ionic Block Copolymer Surfactant as Stabilizer Coatings for Nanoparticle Compositions;” U.S. Pat. No. 5,571,536 for “Formulations of Compounds as Nanoparticulate Dispersions in Digestible Oils or Fatty Acids;” U.S. Pat. No. 5,573,783 for “Redispersible Nanoparticulate Film Matrices With Protective Overcoats;” U.S. Pat. No. 5,580,579 for “Site-specific Adhesion Within the GI Tract Using Nanoparticles Stabilized by High Molecular Weight, Linear Poly(ethylene Oxide) Polymers;” U.S. Pat. No. 5,585,108 for “Formulations of Oral Gastrointestinal Therapeutic Agents in Combination with Pharmaceutically Acceptable Clays;” U.S. Pat. No. 5,587,143 for “Butylene Oxide-Ethylene Oxide Block Copolymers Surfactants as Stabilizer Coatings for Nanoparticulate Compositions;” U.S. Pat. No. 5,591,456 for “Milled Naproxen with Hydroxypropyl Cellulose as Dispersion Stabilizer;” U.S. Pat. No. 5,622,938 for “Sugar Based Surfactant for Nanocrystals;” U.S. Pat. No. 5,718,919 for “Nanoparticles Containing the R(-)Enantiomer of Ibuprofen;” U.S. Pat. No. 5,747,001 for “Aerosols Containing Beclomethasone Nanoparticle Dispersions;” U.S. Pat. No. 5,834,025 for “Reduction of Intravenously Administered Nanoparticulate Formulation Induced Adverse Physiological Reactions;” U.S. Pat. No. 6,045,829 “Nanocrystalline Formulations of Human Immunodeficiency Virus (HIV) Protease Inhibitors Using Cellulosic Surface Stabilizers;” U.S. Pat. No. 6,068,858 for “Methods of Making Nanocrystalline Formulations of Human Immunodeficiency Virus (HIV) Protease Inhibitors Using Cellulosic Surface Stabilizers;” U.S. Pat. No. 6,153,225 for “Injectable Formulations of Nanoparticulate Naproxen;” U.S. Pat. No. 6,165,506 for “New Solid Dose Form of Nanoparticulate Naproxen;” U.S. Pat. No. 6,221,400 for “Methods of Treating Mammals Using Nanocrystalline Formulations of Human Immunodeficiency Virus (HIV) Protease Inhibitors;” U.S. Pat. No. 6,264,922 for “Nebulized Aerosols Containing Nanoparticle Dispersions;” U.S. Pat. No. 6,267,989 for “Methods for Preventing Crystal Growth and Particle Aggregation in Nanoparticle Compositions;” U.S. Pat. No. 6,270,806 for “Use of PEG-Derivatized Lipids as Surface Stabilizers for Nanoparticulate Compositions;” U.S. Pat. No. 6,316,029 for “Rapidly Disintegrating Solid Oral Dosage Form,” U.S. Pat. No. 6,375,986 for “Solid Dose Nanoparticulate Compositions Comprising a Synergistic Combination of a Polymeric Surface Stabilizer and Dioctyl Sodium Sulfosuccinate,” U.S. Pat. No. 6,428,814 for “Bioadhesive nanoparticulate compositions having cationic surface stabilizers;” U.S. Pat. No. 6,431,478 for “Small Scale Mill;” U.S. Pat. No. 6,432,381 for “Methods for Targeting Drug Delivery to the Upper and/or Lower Gastrointestinal Tract,” U.S. Pat. No. 6,592,903 for “Nanoparticulate Dispersions Comprising a Synergistic Combination of a Polymeric Surface Stabilizer and Dioctyl Sodium Sulfosuccinate,” U.S. Pat. No. 6,582,285 for “Apparatus for sanitary wet milling;” U.S. Pat. No. 6,656,504 for “Nanoparticulate Compositions Comprising Amorphous Cyclosporine;” U.S. Pat. No. 6,742,734 for “System and Method for Milling Materials;” U.S. Pat. No. 6,745,962 for “Small Scale Mill and Method Thereof;” U.S. Pat. No. 6,811,767 for “Liquid droplet aerosols of nanoparticulate drugs;” and U.S. Pat. No. 6,908,626 for “Compositions having a combination of immediate release and controlled release characteristics;” all of which are specifically incorporated by reference. In addition, U.S. Patent Application No. 20020012675 A1, published on Jan. 31, 2002, for “Controlled Release Nanoparticulate Compositions,” and WO 02/098565 for “System and Method for Milling Materials,” describe nanoparticulate active agent compositions, and are specifically incorporated by reference herein. None of these references however, specifically describe ways to prepare nanoparticulate compositions of nano-cellulose, nano-chitin and nano-chitosan or the dispersion of these nano-particles in a polymer composition.

The polymers useful in the preparation of the nano-particulate filler/polymer blend is a low molecular weight copolymer (200 to 20,000 mw), or mixture thereof, that are solid at room temperature, with preferred melting point of 50° to 95° C. They are not soluble in water at room temperature, however at temperatures above their melting point they are dispersable in hot water to form an emulsion. Hence, they are commonly known as emulsifiers in the food and cosmetics areas.

It has also been unexpectedly discovered that a combination of one or more surfactants, together with a selected copolymer, will function in the same way as just using the copolymer by itself. The following list of copolymers are the preferred polymers useful in the practice of the present invention without surfactants. This is for illustrative purposes only. Preferably a dispersion aid is used in the polymer/filler blend for best results. Suitable dispersion aids are:

### Monoglycerides and Diglycerides

Glycerol monostearate with a mono content of 40% to 90%. A melting point 40°-56° C., MP (52)=60 C.° PM (90)=65° C. The average molecular weight is 358.56.
Glycerol monolaurate) mono ester content=90%, Melting point=52° to 65° C., Average molecular weight=274.40
Triglyceride (melting point=56° C.)
Glycerol mono-oleate (melting point=60° C.)
Synthetic ester waxes that are prepared by the reaction of fatty acids and fatty alcohols with different carbon chain lengths). M.P.=60° to 75° C., with a straight or branched chain; natural sources of ester wax are beeswax and carnauba wax.
Melting point+78° to 85° C., Candelilla M.P.=67° to 79° C.
Amide Wax-Ethylene bis-stearamide (EBS) MP=72° to 76° C.
   Montan Wax (also known as OP Wax) MP=82° to 95° C.
   Ethylene-Acrylic Acid (EAA) copolymers MP=55° to 60° C.
      Rosin Esters MP=84° to 95° C.

Styrene Maleic Anhydride Copolymers MP=95 C

Other suitable polymers useful in the practice of the present invention include

The preferred polymer useful in the blends of the present invention are generally selected from the group consisting of a low molecular weight copolymers (200 to 20,000 molecular weight), or a mixture thereof, that is solid at room temperature, with a preferred melting point of 50° to 95° C. These are not soluble in water at room temperature, However, at temperatures above their melting point they disperse in hot water to form an emulsion (they are commonly known as emulsifiers in the food and cosmetics areas).

Some work has been done that indicates that a combination of surfactant and selected copolymer will function in the same way as just using a copolymer. Additional work needs to be done in this area. The attached list of copolymers relates only to the preferred polymers used in this development work (without surfactants).

### DETAILED DESCRIPTION OF THE INVENTION

The polymers useful in the preparation of the polymer system of the present invention are a low molecular weight copolymer (200 to 20,000 mw), or mixtures thereof that are solid at room temperature, with a preferred melting point of 50 to 95 C. They are not soluble in water at room temperature, however when heated to temperatures above their melting point, they can be dispersed in hot water to form an emulsion (they have been known to be useful as emulsifiers in the food and cosmetic industries).

It has been known that a combination of a surfactant and selected copolymer will function in the same way as just using a copolymer. The degree of dispersion of the nano filler in a number of thermoplastics, was evaluated to determine how well the concentrate would perform when processed under low shear mixing conditions, without a vacuum. These conditions represent the most critical process conditions that converters (manufactures) of film, fiber, sheet, and blow molded articles and foamed thermoplastics use to make finished commercial products. Under these conditions the dispersion and distribution of the nano filler in all three polymers (thermoplastic) was found to be excellent. There was no indication of agglomeration of the nano filler in any of the compounds made.

The following examples are provided to more specifically set forth and define the process of the present invention. It is recognized that changes may be made to the specific parameters and ranges disclosed herein and that there may be a number of different ways known in the art to change the disclosed variables. And whereas it is understood that only the preferred embodiments of these elements are disclosed herein as set forth in the specification and drawings, the invention should not be so limited and should be construed in terms of the spirit and scope of the claims that follow

### Example 1

### Dispersion Evaluations of Concentrate

The concentrate of the present invention was blended directly with the thermoplastic resin and compounded (melt processed) using a one inch single screw extruder, non-vented with an L/D of 24 to 1. Each compound was pelletized and evaluated for the dispersion and distribution of the filler, using both a visual, microscope and scanning electron microscope (SEM) methods. [4] All samples contain 1% active nano-filler. PolyethyleneE (HDPE 1.6 MI film grade, density 0.96)+1% active Nano-Filler

### Example 2

### Dispersion Evaluation in PE, PP and PLA:

Using the above process to make concentrates, based on nano cellulose crystals, nano cellulose fiber, chitin nano whiskers and nano chitosan is a potential game changer for the development of nano composites and nano filler use in the polymer area. The created concentrates develop maximum dispersion of the nano fillers and excellent distribution in hydrophobic polymers. Nano filler concentrates and products can be made specifically for use in polyethelene (PE), polypropylene (PP), poly-lactic acid (PLA), polyvinyl chloride (PVC) and other thermoplastic resin polymers that are used in the commercial manufacture of film, fiber, foam, sheet and blow molded articles. When blended into the polymer systems, the nano-particle fillers were found to maximize water vapor and gas transmission rates, optimize foaming properties, modify surface properties and improve physical properties. All of this was achieved while optimizing the cost performance of the end product applications.

A commercially scalable process was developed to overcome this challenge. The ability to manufacture a dry free flowing powder or granular (free of water), that eliminates particle agglomeration and develops maximum dispersion of the nano filler in polyethylene (PE), polypropylene (PP), poly-lactic acid (PLA), polyvinyl chloride (PVC) and TPE has been developed. The dispersion of the nano fillers and the contact adhesion between the filler and the polymers is extremely good.

The process development work was done using a number of different fillers (nano cellulose crystals, nano cellulose fiber, nano chitin whiskers and nano chitosan whiskers). The nanofillers will be referred to only as “filler”. The fillers were supplied in water slurry. Solids ranged from 3 to 12 depending on the filler. A Figure of the filler slurry can be seen below (FIG. 1). The filler slurry was added into a heated kettle, along with an equal amount of distilled water.

The mixture was heated and stirred. A dispersion aid G-9 was used for this evaluation; it was added directly into the water slurry mixture, while mixing. A list of all acceptable dispersion aids is detailed in attachment (B). When the temperature of the mixture reached the melting point of the dispersion aid a smooth particle free blend developed (see FIG. 2). Mixing was continued while decreasing the temperature of the blend. As the blend temperature decreases (a few degrees below the melting point of the dispersion aid), a phase change occurred. The solids (filler and dispersion aid) separated from the water phase, see FIG. 3. The solids were filtered from the water, see FIG. 4. The filtered water was clear. The solids can be dried in a vacuum or forced air oven. After drying, the concentrate was ground into a free flowing granule, see FIG. 5.

The granules can be compounded with a thermoplastic and pelletized into a pellet concentrate or compounded directly into a polymer (PE, PP, PLA, PVC and TPE) of choice. It should be noted that this approach is not limited to the listed polymers. The selection of the proper dispersion aid will allow for maximum compatibility and optimum dispersion into other polymer systems.

What I claim is:

1. A method for the preparation of polymer concentrates containing nano-particle size fillers in a polymer or polymer system.

2. The method of claim 1 wherein the polymer or polymer system is selected from hydrophobic polymers, such as polypropylene (homopolymer and copolymers), polyethylene and polyethylene copolymers, poly (lactic acid) based polymers (PLA) and PVC compounds (based on both homopolymers and copolymers).

3. The method of claim 2 wherein the nano-particle size filler is selected from the group consisting of cellulose fibers, cellulose crystals, chitin whiskers and chitosan.

4. The method of claim 3 wherein the nano particle size filler is dispersed uniformly in the polymer or polymer system.

5. The method of claim 4 wherein the nano-particle size filler is mixed with a dispersion aid, resulting in a dry free flowing powder or granule, that is free of water and eliminates particle agglomeration and develops maximum dispersion of the filler in hydrophobic polymers and polymer systems.

6. The method of claim 5 wherein the nano particle size fillers develop superior contact adhesion with the polymer system when mixed therein.

7. A nano particle size filler composition that can be dispersed uniformly.

8. The nano particle size filler of claim 7 wherein the filler is selected from the group consisting of cellulose crystals, cellulose fiber, chitin whiskers and chitosan.
